(19) United States
(12) Patent Application Publication
(10) Pub. No.: US 2015/0310449 A1
(43) Pub. Date: Oct. 29, 2015

(54) MANAGEMENT SYSTEM AND CONTROL METHOD

(71) Applicant: CANON KABUSHIKI KAISHA, Tokyo (JP)

(72) Inventor: Takeshi Kurimoto, Yokohama-shi (JP)

(21) Appl. No.: 14/694,749

(22) Filed: Apr. 23, 2015

(30) Foreign Application Priority Data
Apr. 25, 2014 (JP) 2014-091589

(51) Int. Cl. G06Q 30/00

(52) U.S. Cl. CPC G06Q 30/016

(57) ABSTRACT

A device management server acquires management information from a network environment of a specific customer and registers the management information on a saving unit in association with a customer identifier of a specific customer in a case where the acquired management information is not managed in the saving unit. Further, in a case where the management information has already been managed in the saving unit and the customer identifier of the specific customer is different from the customer identifier associated with the management information already managed by the saving unit, the device management server notifies the management company that a trial of the service is carried out repeatedly.

### BACKGROUND OF THE INVENTION

1. Field of the Invention

The present invention relates to a technique for managing management information necessary to provide a service to customers.

2. Description of the Related Art

As a conventional method for identifying the identity of a customer environment having a device as a management target in a device management system, there has been provided a method using a hardware identification number of an information processing apparatus operated by a customer communicating with the device management system (see Japanese Patent Application Laid-Open No. 2002-157523).

Generally, when a group of devices in one customer environment is managed by a device management system, a service contract is previously made between a management company operating the device management system and a customer, and the customer makes a payment for a service fee stated in the service contract to the management company. However, the customer may feel uncomfortable about making the service contract without being assured of the advantageous effect of introducing the system. Therefore, in order to help the customer to determine whether to make the service contract, there may be a case where the customer is allowed to carry out a trial of the system before making the service contract.

In many cases, the trial is carried out free of charge or at a low price. Further, the trial normally has an expiration date, and the customer may not be able to use the device management system after the expiration date, or may infringe the contract or have to pay regular service fee if the customer keeps using the device management system after the expiration date. If the customer repeatedly carries out the trial even after the expiration date, the customer can continuously enjoy the benefit of using the device management system free of charge or at a low price, whereas the management company will suffer a loss of profit.

Therefore, it is necessary to provide a method enabling the device management system to identify the identity of the customer environment to allow the management company to be aware of the identity thereof. Further, a customer already carried out the trial in the past may repeatedly carry out the trial by mistake due to change in a person in charge, or a customer may repeatedly carry out the trial without sending an official notice. In the above cases, the management company should have made a new offer to the customer while considering the situation where the customer has ended the trial without making the service contract. Therefore, it is also necessary to provide a method enabling the management company to identify and to be aware of the identity of the customer environment.

According to the conventional technique discussed in Japanese Patent Application Laid-Open No. 2002-157523, the identity of the environment is identified by comprehensively using the information such as media access control (MAC) addresses and serial numbers of a plurality of hardware devices included in a single information processing apparatus for communicating with the system. However, this technique can only identify the information processing apparatus itself. In other words, as there may be a case where one information processing apparatus is relocated to another environment managed by another customer for some reasons, this technique is problematic in that the information is not appropriate for identifying the identity of the customer environment.

For example, the information processing apparatus is relocated to another environment managed by another customer when the information processing apparatus that has been leased to a customer A under one lease contract is leased to a customer B under another lease contract after termination of the one lease contract with the customer A. Further, the information processing apparatus is also relocated to another environment managed by another customer when the information processing apparatus originally purchased by the customer A is purchased by the customer B through a secondhand goods dealer or another distributor. With the above-described conventional technique, in such the above-described situations, the customers A and B will be identified as an identical customer environment if the customers A and B respectively carry out the trial of the device management system when that information processing apparatus is operated at their operation sites. Such a determination result causes the management company to erroneously recognize that the trial is repeatedly carried out by the customer B, and thus the management company may take a certain action with respect to the customer B. However, because the customer B legitimately carries out the trial in the above-described situation, the management company may lose credibility with the customer B as well as the society.

### SUMMARY OF THE INVENTION

The present invention is directed to a system capable of judging and detecting with a high credibility whether a customer has already received a special service when the special service is provided to the customer.

According to an aspect of the present invention, a management system configured to manage management information necessary for a service provider to provide a service to a customer for each customer, includes a generation unit configured to generate a customer identifier for identifying a specific customer when special provision of the service is started for the specific customer, an acquisition unit configured to acquire management information from a network environment of the specific customer whose customer identifier is generated by the generation unit, a management unit configured to manage the management information acquired from the network environment of the specific customer in association with the specific customer identifier in order to manage the customer to whom the special provision of the service has been implemented, a registration unit configured to register the management information on the management unit in association with the customer identifier of the specific customer in a case where the management information is acquired from the network environment of the specific customer and if the management information is not managed by the management unit, a notification unit configured to send a notification in a case where the management information is acquired from the network environment of the specific customer, if the management information has already been managed by the management unit, and the customer identifier of the specific customer generated by the generation unit is different from the customer identifier associated with the management information already managed by the management unit.

Further features of the present invention will become apparent from the following description of exemplary embodiments with reference to the attached drawings.

### BRIEF DESCRIPTION OF THE DRAWINGS

FIG. 1 is a diagram illustrating a system configuration of a device management system according to an exemplary embodiment.

FIG. 2 is a block diagram illustrating a hardware configuration of an image forming apparatus.

FIG. 3 is a block diagram illustrating a hardware configuration of a device management server and a client terminal.

FIG. 4 is a block diagram illustrating a software configuration of the device management system.

FIGS. 5A and 5B are data tables for managing a combination of a customer identifier and a device identifier.

FIG. 6 is a diagram illustrating an e-mail notified through notification processing.

FIG. 7 is a diagram illustrating a web page displayed through the notification processing.

FIG. 8 is a flowchart illustrating processing executed by the device management server according to a first exemplary embodiment.

FIG. 9 is a flowchart illustrating processing executed by the device management server according to a second exemplary embodiment.

FIG. 10 is a flowchart illustrating processing executed by the device management server when a customer has ended a trial.

### DESCRIPTION OF THE EMBODIMENTS

Hereinafter, a first exemplary embodiment of the present invention will be described with reference to the appended drawings.

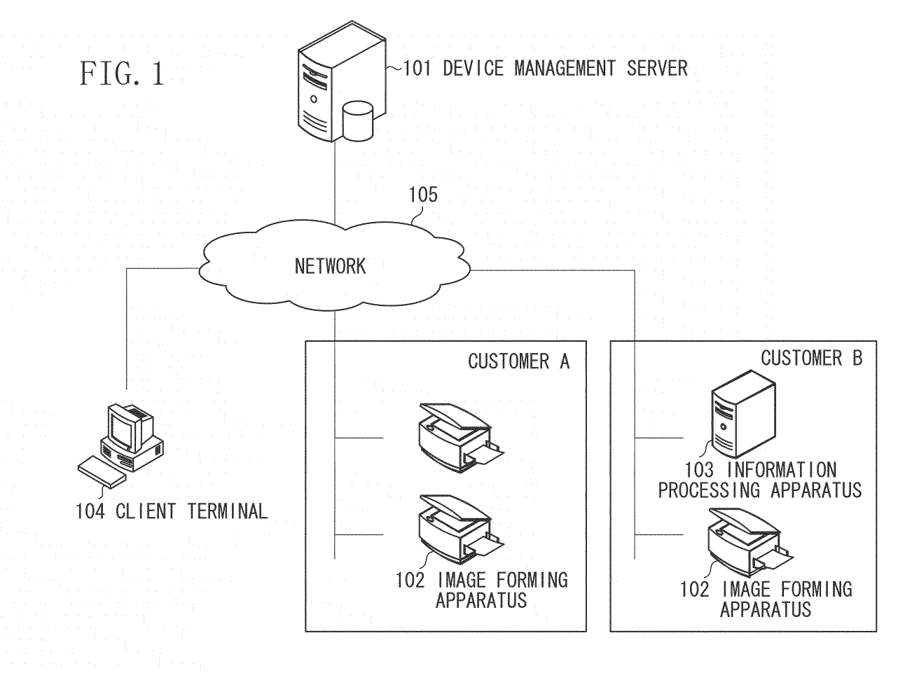

Each device constituting a device management system according to the present exemplary embodiment will be described with reference to FIG. 1.

FIG. 1 is a diagram illustrating an example of a configuration of the device management system according to the present exemplary embodiment.

As illustrated in FIG. 1, in the device management system according to the present exemplary embodiment, a device management server 101, image forming apparatuses 102, an information processing apparatus 103, and a client terminal 104 are connected to each other via a network 105. In the present exemplary embodiment, the image forming apparatuses 102 are grouped and managed in units of network environments of customers A and B.

In the environment of the customer A, the image forming apparatus 102 directly communicates with the device management server 101. In the environment of the customer B, the image forming apparatus 102 incapable of directly communicating with the device management server 101 is connected to the device management server 101 via the information processing apparatus 103. The device management server 101 manages management information necessary for a service provider to provide a service to the customer, for each customer. The service provider may be a management company operating a device management system or another management company entrusted the operation from the management company.

The client terminal 104 is not limited to a personal computer, but may be an image forming apparatus or a mobile terminal having the equivalent functions. The network 105 is a communication line enabling the above-described devices to exchange information, and any type of network such as the internet, an intranet, a wired or a wireless network may be employed therefor.

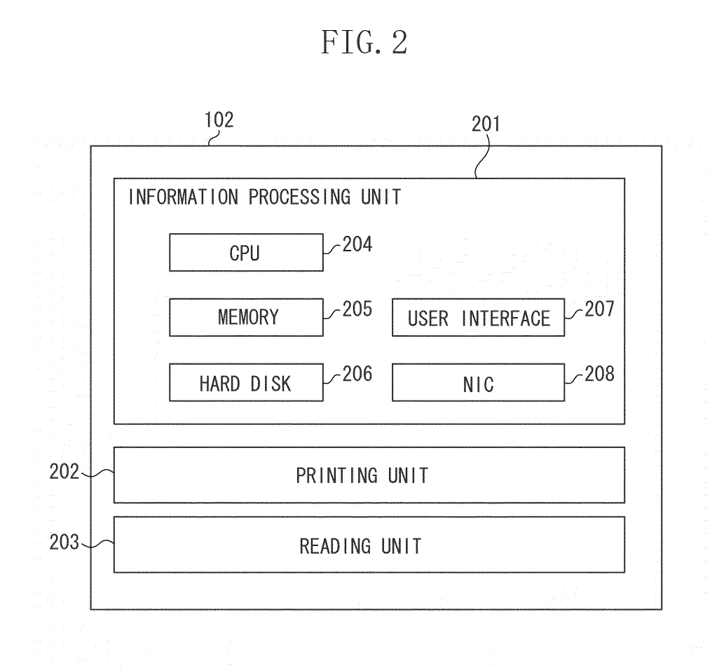

Subsequently, a hardware configuration of each device constituting the device management system will be described. FIG. 2 is a block diagram illustrating a hardware configuration of the image forming apparatus 102.

As illustrated in FIG. 2, the image forming apparatus 102 includes an image processing unit 201, a printing unit 202, and a reading unit 203. The reading unit 203 may not be included therein if the image forming apparatus 102 is not a multifunction peripheral.

The image processing unit 201 includes a central processing unit (CPU) 204, a memory 205, a hard disk 206, and a user interface 207. The CPU 204 realizes various functions by executing various programs. The memory 205 temporarily stores various kinds of information, and the CPU 204 executes a program stored in the hard disk 206 by loading the program onto the memory 205. Further, the memory 205 is also used as a temporary work storage area. The hard disk 206 is a unit for storing various types of data, and hardware such as a flash memory having the equivalent functions may be employed therefor.

The user interface 207 receives a processing request from a user and outputs a screen for the user. A network interface card (NIC) 208 connects the image forming apparatus 102 to the network 105. In addition, although a typical hardware configuration of the image forming apparatus 102 is illustrated in FIG. 2, the configuration of the image forming apparatus 102 is not limited thereto. For example, the image forming apparatus 102 may be configured in such a manner that a fax board or an external control device is connected thereto.

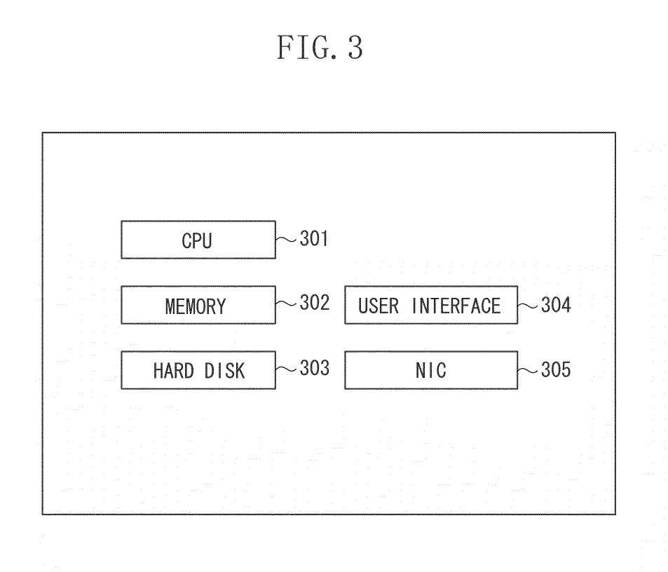

FIG. 3 is a block diagram illustrating a hardware configuration of the device management server 101, the information processing apparatus 103, and the client terminal 104.

In FIG. 3, a CPU 301 realizes various functions by executing various programs. A memory 302 temporarily stores various kinds of information, and the CPU 301 executes a program stored in a hard disk 303 by loading the program onto the memory 302. The memory 302 is also used as a temporary work storage area. The hard disk 303 is a unit for storing various types of data, and hardware such as a flash memory having the equivalent functions may be employed therefor.

A user interface 304 receives a processing request from the user and outputs a screen for the user. A NIC 305 connects the device management server 101, the information processing apparatus 103, and the client terminal 104 to the network 105, so that each of the above devices can connect to the network through the NIC 305. In addition, although a typical hardware configuration of the device management server 101, the information processing apparatus 103, and the client terminal 104 is illustrated in FIG. 3, the configuration thereof is not limited thereto.

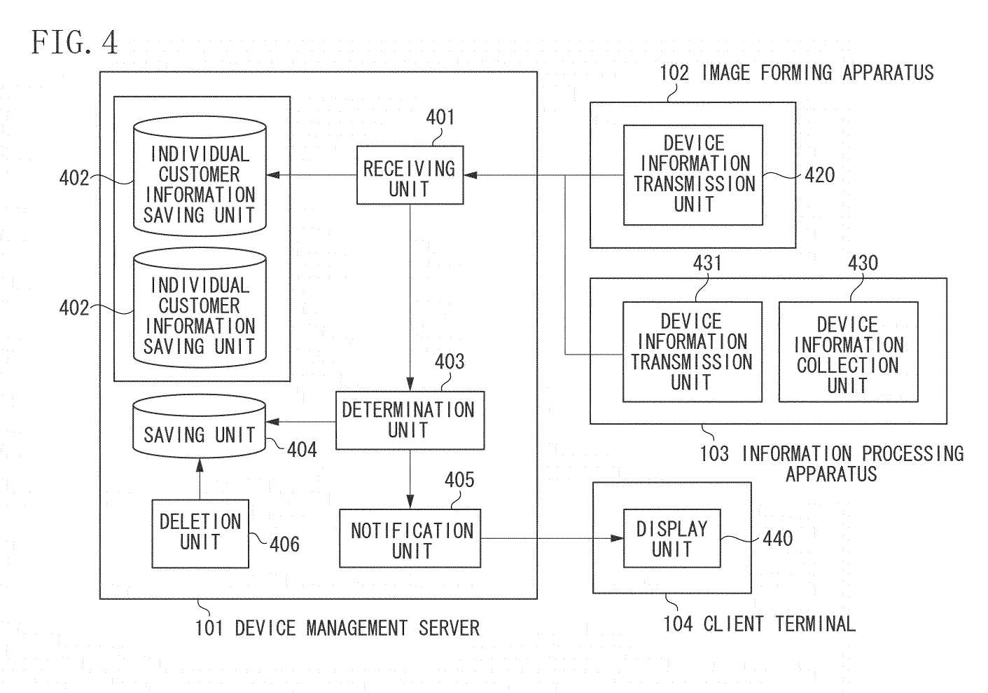

FIG. 4 is a block diagram illustrating a software configuration of each device constituting the device management system. A program for realizing the function of the software configuration of the image forming apparatus 102 is stored in the hard disk 206 of the image forming apparatus 102, and the function is realized when the CPU 204 of the image forming apparatus 102 loads and executes the program on the memory 205. Further, programs for realizing the functions of the software configurations of respective devices such as the device management server 101, the information processing apparatus 103, and the client terminal 104 are stored in the hard disks 303 of the respective devices, and the functions are realized when the CPUs 301 of the respective devices load and execute the programs on the memories 302.

First, a software configuration of the image forming apparatus 102 will be described.

A device information transmission unit 420 transmits various kinds of information stored in the image forming apparatus 102 or various kinds of information generated by using the image forming apparatus 102, to the device management server 101. For example, the various kinds of information may be the information such as device information, setting information, a job execution history, information on occurrence of errors, activation information, information on consumables, an operation history, information on service operation, and information on inquiries but are not limited to the specific information. Further, for example, the device information may be a media access control (MAC) address, a serial number, a lot number, a product name, or a manufacturer name set thereto prior to the shipment of the product and cannot be changed by the customer but is not limited to the specific information. Hereinafter, the various kinds of information described above are referred to as the device information. Further, the image forming apparatus 102 without having the device information transmission unit 420 (e.g., the image forming apparatus 102 operating in the environment of the customer B in FIG. 1) may also exist although it is not illustrated in FIG. 4.

Next, a software configuration of the information processing apparatus 103 will be described.

A device information collection unit 430 collects the device information from the image forming apparatus 102 not having the device information transmission unit 420. The information is collected through any method at any interval. A device information transmission unit 431 transmits the collected device information to the device management server 101. With this configuration (i.e., the environment of the customer B illustrated in FIG. 1), even if the image forming apparatus 102 cannot transmit the device information, the device information thereof can be collected and transmitted to the device management server 101 via the information processing apparatus 103.

Next, a software configuration of the device management server 101 will be described.

A receiving unit 401 receives the device information transmitted from the image forming apparatus 102 or the information processing apparatus 103. Further, the receiving unit 401 identifies from which customer environment the device information is transmitted by using a method such as an authentication method. At this time, the customer environments of the customers A and B illustrated in FIG. 1 are uniquely identified by customer identifiers allocated thereto in the device management system. In addition, the customer identifier is an identifier newly created and allocated when customer data is created by the device management system. Accordingly, allocating a plurality of customer identifiers with respect to one customer by repeatedly creating the customer data is allowed by the system. For example, the customer identifier is created when provision of the service (including provision of the service as a trial) is started with respect to the customer.

Further, the receiving unit 401 saves the received device information in an individual customer information saving unit 402 corresponding to the customer identifier. As described above, because the device information includes confidential information and personal information of each customer, the individual customer information saving unit 402 separately stores the device information for each customer environment in order to maintain security to protect the information. The device information can be separately stored at each customer environment by the methods such as using a separate database (DB), using a separate table, distinguishing the device information by using an identification (ID) within the table, or using a separate access right at each customer environment. However, the method thereof is not limited to the specific methods.

Further, the receiving unit 401 acquires a service state of the customer environment from the individual customer information saving unit 402, and determines whether the service state of the customer environment is “trial period”. The above-described service state is set or changed by the user. Typical examples of setting or changing the service state will be described below.

As a typical example of setting the service state, there may be a case where the user selects and sets the service state to “trial period (i.e., special service provision)” or “regular provision (i.e., normal service provision)” through a user interface (UI) displayed on the screen provided by the device management system when the user newly creates customer data on the device management system. This user may be the management company operating the device management system, another management company entrusted the operation from the management company, or the customer himself/herself. Further, as another typical example of setting the service state, there may be a case where an instruction for newly creating the customer data from another system by using a web service or an application program interface (API) opened on the outside of the system by the device management system, and the service state is set when the customer data is created based on that instruction. In any of the above examples, the service state may be set to “trial period” or “regular provision” as a default value if the service state is not specified in particular.

Further, as a typical example of changing the service state, there may be a case where the service state is changed to “regular provision” when the user shifts the customer data to the regular provision on the device management system. Furthermore, as another typical example of changing the service state, there may be a case where an instruction for changing the service state is transmitted from another system by using the API opened to the outside of the system by the device management system, and the service state is changed based on that instruction.

The receiving unit 401 may be able to acquire a true-false value representing whether the service state is “trial period”, or may be able to acquire a value representing the service state such as “trial period”, “regular provision”, or “others”. However, at least in the present exemplary embodiment, the receiving unit 401 transmits the customer identifier and the device information to a determination unit 403 when the receiving unit 401 determines the service state to be “trial period”. In addition, the above determination may be executed by the receiving unit 401 or the determination unit 403.

The determination unit 403 extracts the device identifier for uniquely identifying the device from the device information received from the receiving unit 401. Although the MAC address or the serial number is normally used as the device identifier for uniquely identifying the device, any processed or unprocessed information capable of uniquely identifying the device can be used as the device identifier. Further, the device identifier may have uniqueness only with a combination of two or more pieces of information.

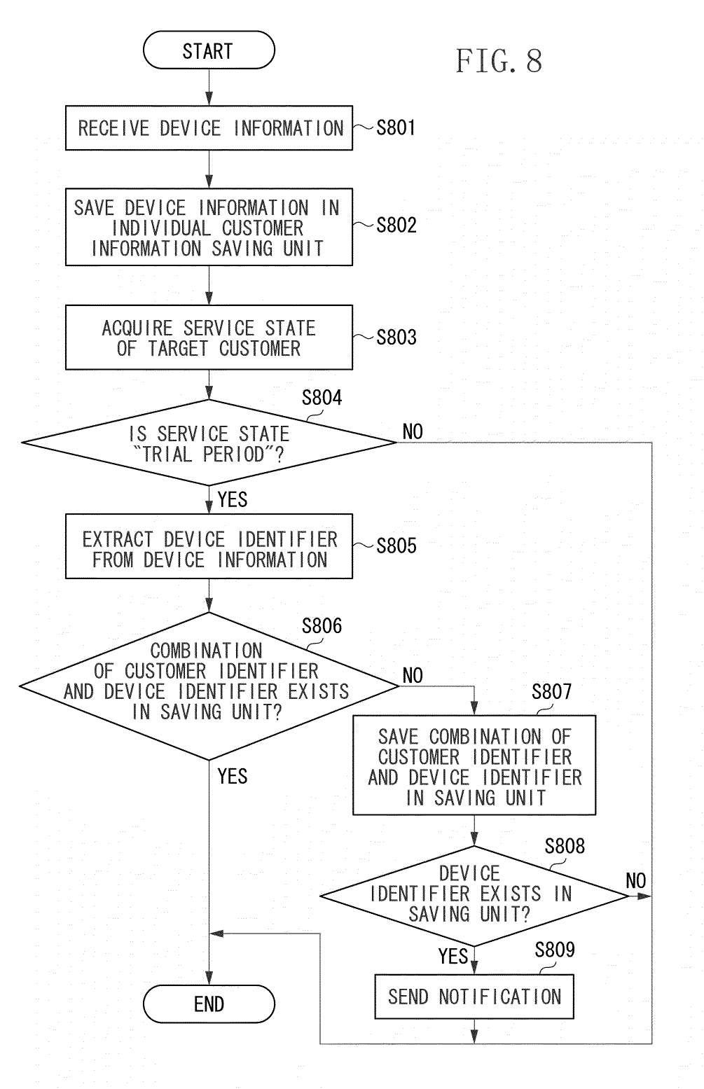

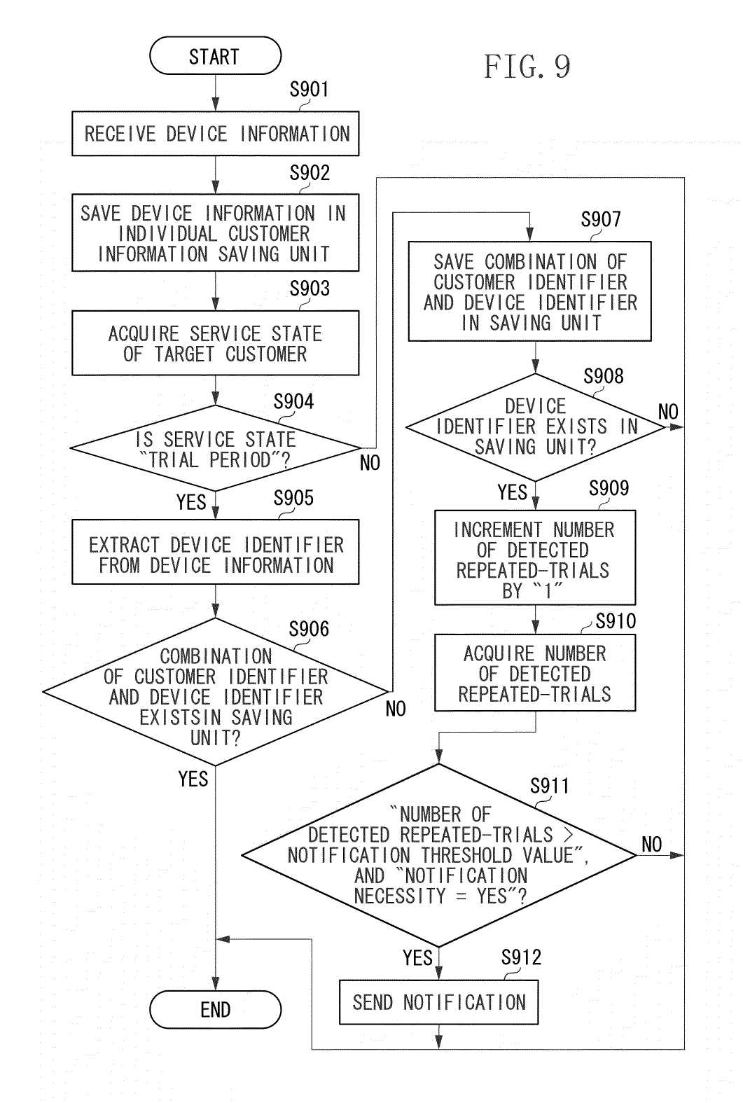

When the combination of the customer identifier and the device identifier is input, the determination unit 403 makes an inquiry to a saving unit 404 to determine whether the device identified by the device identifier has carried out the trial, and whether there is any problem in a case where the device has carried out the trial. Further, according to the determination result, the determination unit 403 may control the operations of the saving unit 404 and a notification unit 405, or may control nothing. The above determination and the processing to be executed according to the determination result will be described below in detail with reference to the flowcharts illustrated in FIGS. 8 and 9.

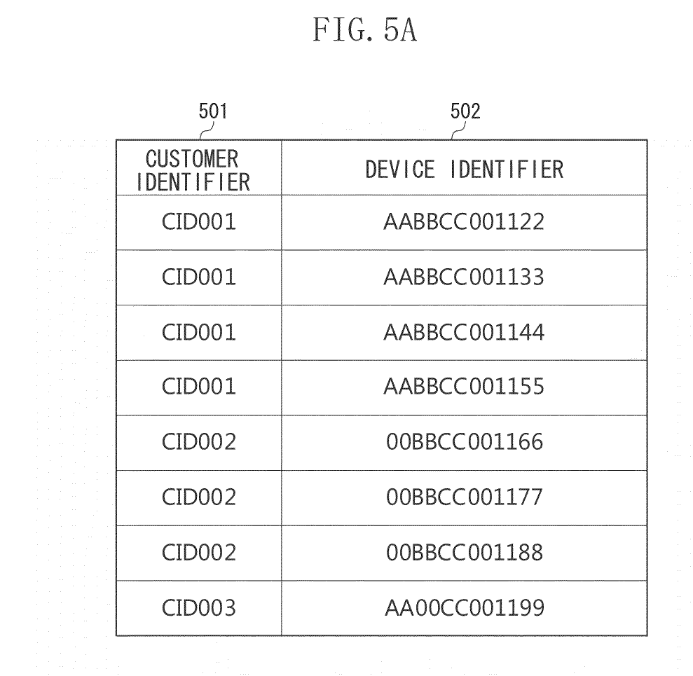

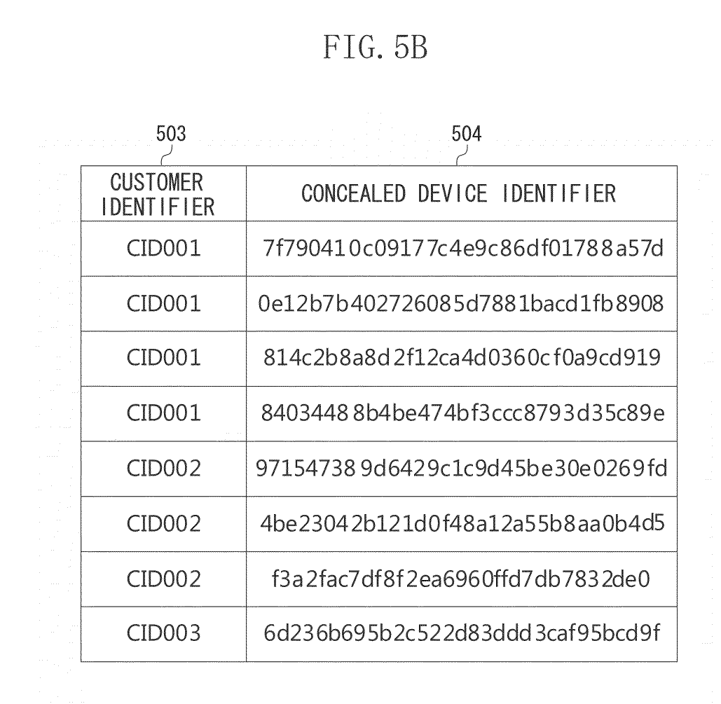

The saving unit 404 stores zero or more combinations of the customer identifier and the device identifier. As illustrated in FIG. 5A, the combination of the customer identifier and the device identifier is configured of the device identifier of the device whose trial has already been carried out, and the customer identifier indicating the customer environment from which the device information as a source of that device identifier is transmitted. The combination of the customer identifier and the device identifier is unique in the saving unit 404. Herein, the term “unique” means a state where the combinations identical to each other do not exist. As described above, the saving unit 404 manages the device identifier acquired from the network environment of the customer, in association with the customer identifier of the customer.

Further, although it is not illustrated in FIG. 5A, the saving unit 404 can save below-described zero or more customer identifiers to which customer the notification is not sent. A typical method for saving the customer identifier may be to add customer identifier of the target customer by setting a checkbox of “DO NOT SEND NOTIFICATIONS TO THIS CUSTOMER FROM NOW ON” to “ON” at the web page displayed in response to the above notification. Further, the saving unit 404 may be configured of a data structure having a combination of all of the created customer identifiers or the customer identifiers of all of the customers whose customer environment states are “trial period”, and a true-false value representing notification necessity of the customer in expired trial period, in addition to the above data structure for saving zero or more customer identifiers to which customers the notifications are not sent. Alternatively, the saving unit 404 may be configured of a data structure in which the true-false value representing the notification necessity of the customer in expired trial period is managed by the individual customer information saving unit 402.

FIG. 5A is a data table for managing the combination of the customer identifier and the device identifier saved in the saving unit 404 according to the present exemplary embodiment.

In the example illustrated in FIG. 5A, a customer ID allocated to each customer by the device management system is saved in a column of a customer identifier 501. Further, a character string acquired by eliminating symbols from the MAC address extracted from the device information of the device transmitted from the customer environment corresponding to the customer ID is saved in a column of a device identifier 502.

The notification unit 405 notifies the user that one customer is likely to have carried out a trial of the device management system in the past. This user may be a staff member in charge of management of the customer environment of the customer, a staff member of an operating company in charge of the operation of the device management system, or a staff member of a company entrusted the operation from any of these companies.

If the above user is a staff member of the management company, the user can be aware that the management target customer is likely to have carried out the trial of the device management system in the past by receiving the above notification. In this case, the user can determine the subsequent action to be taken depending on whether the second trial is started because of an offer from the user or a request from the customer.

For example, if the trial is started because of the offer from the user and that offer is made by mistake, the user can express the apology to ask the customer for termination of the trial or make another offer again. Further, if the trial is started because of the offer from the user and the user is aware of the implementation of the second trial, for example, the user may leave the second trial without taking any action, or may offset that the notification is not sent from that point of time. In addition, a setting method for not sending the notification will be described below.

On the other hand, if the trial is started because of the request from the customer, for example, the user may inquire of the customer about a reason for repeating the trial. For example, the above inquiry and an inquiry described below are made through an interview, a phone call, an e-mail, or other communication tools. If the customer would like to repeat the trial because the customer environment has been changed since the last trial, for example, the user can make a suitable offer by checking details of changes in the customer environment. Further, if the customer would like to repeat the trial because functions of the device management system have been increased since the last trial, for example, the user can make a presentation of the functions to the customer. Furthermore, if the customer repeats the trial in order to continuously use the system free of charge or at a low price, for example, the user can negotiate with the customer to terminate the trial or to shift the provision of the system from the trial to the regular provision.

Further, if the above user is a staff member of the operation company, for example, by receiving the above notification, the user can inform the management company that the management company is likely to allow a customer already carried out the trial in the past to repeat the trial by mistake.

In addition, the above notification is notified to the user by an e-mail. A mail address is set by the user and saved in the saving unit 404. In a case where the above notification is notified to the user by an e-mail, notification necessity may desirably be determined at a regular or a predetermined interval by taking convenience of the user into consideration. For example, the notification necessity may be determined at 9 a.m., 12 a.m., and 4 p.m. on weekdays in order to send a notification if necessary. Further, the above notification may be included in the display information that is to be transmitted when the user accesses the web page generated by the device management system. The display information is received by the client terminal 104, and the user can check the display information as the information displayed on a display unit 440 described below.

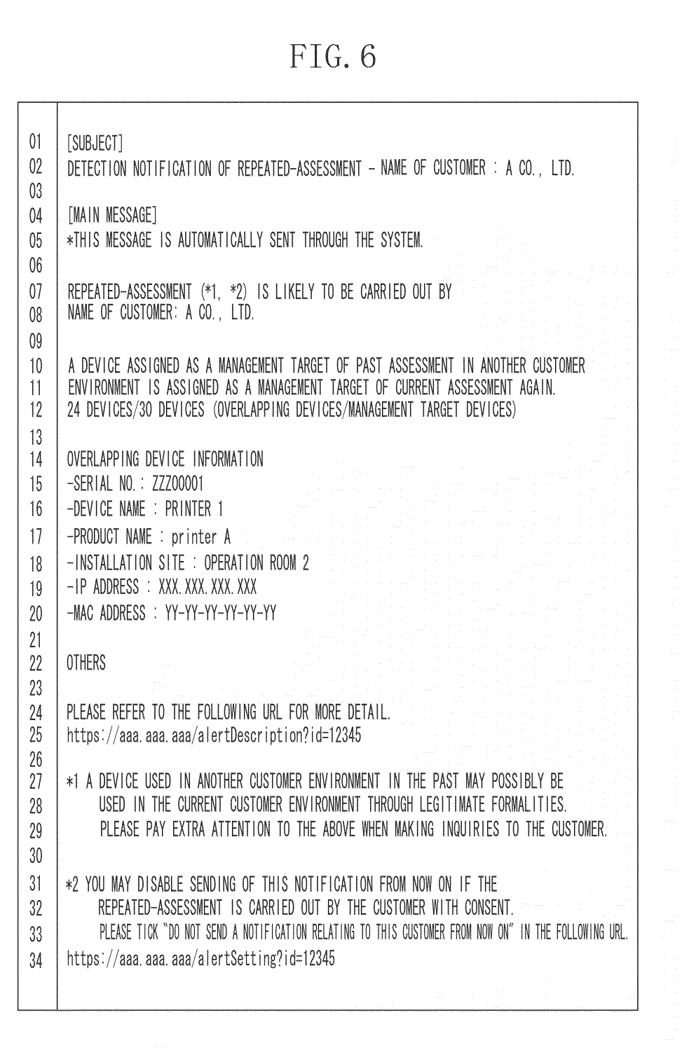

FIG. 6 is a diagram illustrating an e-mail notified to the user from the notification unit 405.

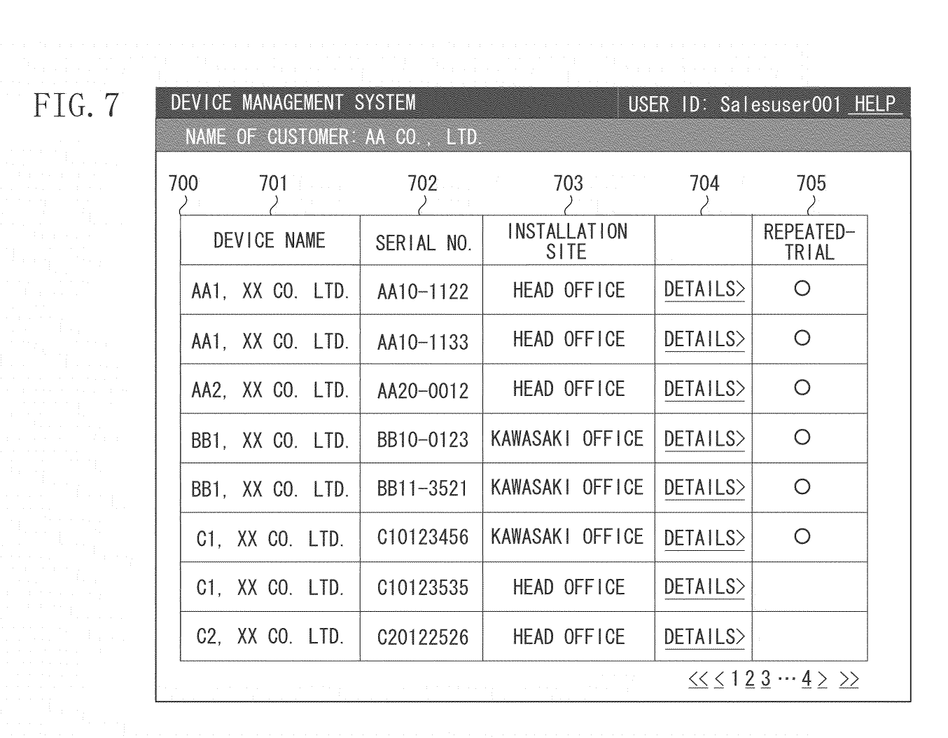

In the example illustrated in FIG. 6, the number of the devices determined by the determination unit 403 that the device information thereof is likely to be the same as the device information managed in the past trial is described on the 12th line of the e-mail. Further, the device information determined that the device information is likely to be the same as the device information managed in the past trial is described on the 14th to 20th lines. Further, in a case where only a part of the device information can be described on the main message of the e-mail or it may not be desirable for the security, a uniform resource locator (URL) for allowing the user to shift a screen to the web page generated by the device management system (see FIG. 7) is provided on the 25th line. In addition, in order to display the above web page, user authentication is executed to ensure the security.

FIG. 7 is a diagram illustrating an example of the web page displayed by the notification unit 405.

In the example illustrated in FIG. 7, one row in a table 700 corresponds to one device. Further, columns of the table 700 respectively include a device name 701, a serial No. 702, and an installation site 703 serving as a part of the device information, a link 704 for displaying a screen for allowing the user to check the details of the device information, and a repeated-trial 705 indicating presence or absence of the repeated-trial (i.e., also referred to as “overlapped-trial”). A symbol “o” is displayed in the column of the repeated-trial 705 if the determination unit 403 determines that the device information is likely to be the same as that managed in the past trial, whereas no symbol is displayed in the column of the repeated trial 705 if the device is not applicable to the above determination. In order to check the details of the device information, the user can shift the screen to a screen of detailed device information by specifying the link 704 through the user interface 304 (i.e., by clicking the link 704 with a mouse).

Hereinafter, description will be given with reference to FIG. 4 again.

A deletion unit 406 of the device management server 101 can delete all of the combinations of the customer identifier and the device identifier having the same customer identifier from the saving unit 404 when a customer identifier is input. Further, the deletion unit 406 can delete a part of the combinations of the customer identifier and the device identifier having that received customer identifier from the saving unit 404 when a customer identifier is input. Furthermore, the deletion unit 406 can delete all of the combinations of the customer identifier and the device identifier saved in the saving unit 404. The functions of the deletion unit 406 will be described below in detail. In addition, the deletion unit 406 may not exist depending on the aspect of the exemplary embodiment.

Next, a software configuration of the client terminal 104 will be described.

The display unit 440 displays display information, e.g., as illustrated in FIG. 7 received from the device management server 101. The display unit 440 may be dedicated software or general-purpose software such as a web browser as long as the display information can be received and displayed thereby. Furthermore, if the notification unit 405 sends a notification of the customer in an expired trial period through an e-mail, the display unit 440 may be configured of software such as mailer software allowing the user to check the content thereof.

FIG. 8 is a flowchart illustrating an example of flow of processing executed by the device management server 101 according to the present exemplary embodiment. The CPU 301 of the device management server 101 executes the program stored in the hard disk 303 to realize the processing of this flowchart.

In step S801, the receiving unit 401 of the device management server 101 receives the device information transmitted from the device information transmission unit 420 or 431 included in the image forming apparatus 102 or the information processing apparatus 103. Then, the processing proceeds to step S802. The information included in the device information has been described as the above. In addition, the processing of this flowchart is executed when the receiving unit 401 receives the device information that is not saved in the individual customer information saving unit 402. In a case where the receiving unit 401 receives the device information already saved in the individual customer information saving unit 402, the device information is processed through processing different from the processing described above (not illustrated), although details thereof will be omitted.

In step S802, the receiving unit 401 saves the device information received in step S801 in the individual customer information saving unit 402, and the processing proceeds to step S803. In step S803, the receiving unit 401 identifies a target customer environment (i.e., customer identifier) based on which customer environment has transmitted the device information received in step S801, and acquires a service state of that customer environment from the individual customer information saving unit 402. A method for setting or changing the service state of the customer environment is as described above.

Next, in step S804, the receiving unit 401 determines whether the service state of the customer environment acquired in step S803 is “trial period”. In a case where the receiving unit 401 determines that the service state is not the trial period (NO in step S804), the receiving unit 401 ends the processing of this flowchart. On the other hand, in a case where the receiving unit 401 determines that the service state is the trial period (YES in step S804), the receiving unit 401 transmits the customer identifier and the device information to the determination unit 403. Then, the processing proceeds to step S805.

In step S805, the determination unit 403 extracts the device identifier from the above-described device information. Subsequently, in step S806, the determination unit 403 determines whether the combination of the customer identifier uniquely identifying the customer and the device identifier extracted in step S805 exists in the saving unit 404.

In step S806, in a case where the determination unit 403 determines that the combination of the customer identifier uniquely identifying the customer and the device identifier extracted in step S805 exists in the saving unit 404 (YES in step S806), the determination unit 403 ends the processing of this flowchart.

The processing is ended when the above-described combination exists (i.e., when the determination is “YES” in step S806) because of the following reason.

The case where the combination of the customer identifier and the device identifier already exists in the saving unit 404 is a case where t the device information saved in the individual customer information saving unit 402 in the past has been deleted from the individual customer information saving unit 402 for some reasons at the current trial implemented in the customer environment. In other words, in this case, because the combination of the customer identifier and the device identifier has already been saved in the saving unit 404, saving processing subsequently executed in step S807 is not necessary. Therefore, in this case also, the processing of this flowchart is ended without executing any processing. In addition, when the device information is deleted from the individual customer information saving unit 402, the device identifier corresponding to that device information is not deleted from the saving unit 404. This is because even if the device information has been deleted from the individual customer information saving unit 402 for some reasons, the fact that the device has existed in that customer environment can be used for identifying the identity of the customer environment.

On the other hand, in step S806, in a case where the determination unit 403 determines that the combination of the customer identifier uniquely identifying the customer and the device identifier extracted in step S805 does not exist in the saving unit 404 (NO in step S806), the processing proceeds to step S807. In step S807, the determination unit 403 saves the combination of the customer identifier and the device identifier in the saving unit 404. Then, the processing proceeds to step S808. In other words, in a case where the device identifier included in the device information acquired from the network environment of the customer is not managed by the saving unit 404, the determination unit 403 registers the device identifier on the saving unit 404, in association with the customer identifier of the customer.

In step S808, the determination unit 403 determines whether the device identifier exists in the saving unit 404. In a case where the determination unit 403 determines that the device identifier does not exist in the saving unit 404 (NO in step S808), the determination unit 403 ends the processing of this flowchart.

On the other hand, in a case where the determination unit 403 determines that the device identifier exists in the saving unit 404 (YES in step S808), the processing proceeds to step S809. In this case, the same device identifier is saved in the saving unit 404 as a combination of the device identifier and another customer identifier.

Therefore, in step S809, the notification unit 405 notifies the user of the information (e.g., the information illustrated in FIG. 6) indicating that the target customer is likely to have carried out the trial repeatedly. The notification method thereof is as described above.

As described above, when the device management system manages a group of devices in a certain customer environment, it is possible to determine and detect whether the trial of the service has been carried out in that customer environment in the past more reliably than in the conventional technique.

In many cases, the customer having carried out the repeated-trial can be correctly detected and determined by the determination method using the device identifier described in the first exemplary embodiment. However, with the method described in the first exemplary embodiment, for example, in a case where one device is leased to another customer or purchased by another customer as a secondhand device, another customer may be determined to be the same customer erroneously.

FIG. 9 is a flowchart illustrating an example of a flow of processing executed by the device management server 101 according to a second exemplary embodiment. The CPU 301 of the device management server 101 executes a program stored in the hard disk 303 to realize the processing of this flowchart.

The processing in steps S901 to S908 is the same as the processing in steps S801 to S808 in FIG. 8, and thus the description thereof will be omitted. However, in a case where the determination unit 403 determines that the device identifier exists in the saving unit 404 (YES in step S908), the processing proceeds to step S909.

In step S909, the determination unit 403 increments the number of detected repeated-trials managed at each customer by “1”. Then, the processing proceeds to step S910. In addition, a value for the number of detected repeated-trials is stored in the saving unit 404, and the initial value thereof is set to “0”.

In step S910, the determination unit 403 acquires a value of the number of detected repeated-trials from the saving unit 404 and transmits the value to the notification unit 405. The processing in steps S909 and S910 is separately described because the processing in steps S909 and S910 may be executed at different timing depending on the implementation method of the notification processing subsequently executed in step S912. For example, in the case of notification using an e-mail, the processing in steps S909 and S910 are executed consecutively. On the other hand, in the case of notification using a web page, although the processing in step S909 is processed similarly as in the case of notification using an e-mail, the processing in step S910 is processed at a timing when the user displays the web page.

In step S911, the determination unit 403 determines whether the number of detected repeated-trials acquired by the notification unit 405 in step S910 satisfies the notification condition while the value of the notification necessity with respect to the target customer acquired from the saving unit 404 is “YES”. If the number of detected repeated-trials does not satisfy the notification condition, or the value of the notification necessity with respect to the target customer acquired from the saving unit 404 is “NO” (NO in step S911), the determination unit 403 ends the processing of the flowchart.

On the other hand, in step S911, if the number of detected repeated-trials satisfies the notification condition while the value of the notification necessity with respect to the target customer acquired from the saving unit 404 is “YES” (YES in step S911), the processing proceeds to step S912. In step S912, the notification unit 405 notifies the user that the target customer is likely to have carried out the trial repeatedly. The notification method is as described above.

A condition such as whether the number of detected repeated-trials exceeds a predetermined threshold value or whether the number of detected repeated-trials in the entire pieces of received device information exceeds a predetermined ratio is taken as the notification condition. In the flowchart of FIG. 9, the former condition is described as an example. The threshold value or the ratio may be set by the system as a fixed value, or may be set by the manager or the user and saved in the saving unit 404. Further, the threshold value or the ratio may have a different value for each customer identifier, or may have a common value for all of the customer identifiers. In addition, the false detection of the repeated-trial is less likely to occur as the threshold value or the ratio has a greater value. On the contrary, as with the case of the conventional technique, the false detection of the repeated-trial is more likely to occur as the threshold value or the ratio has a lower value. Therefore, the value thereof may desirably be changeable as appropriate according to the operation when the above-described processing is to be executed. A setting method for the notification necessity saved in the saving unit 404 is as described above.

As described above, the repeated-trial of the service carried out by the customer can be detected more precisely while a false notification of the repeated-trial can be reduced.

According to a third exemplary embodiment, in comparison to the first and the second exemplary embodiments, detection precision of the repeated-trial or speed of searching for data in the saving unit 404 can be further improved. In the present exemplary embodiment, only the processing different from the processing described in the first and the second exemplary embodiments will be described.

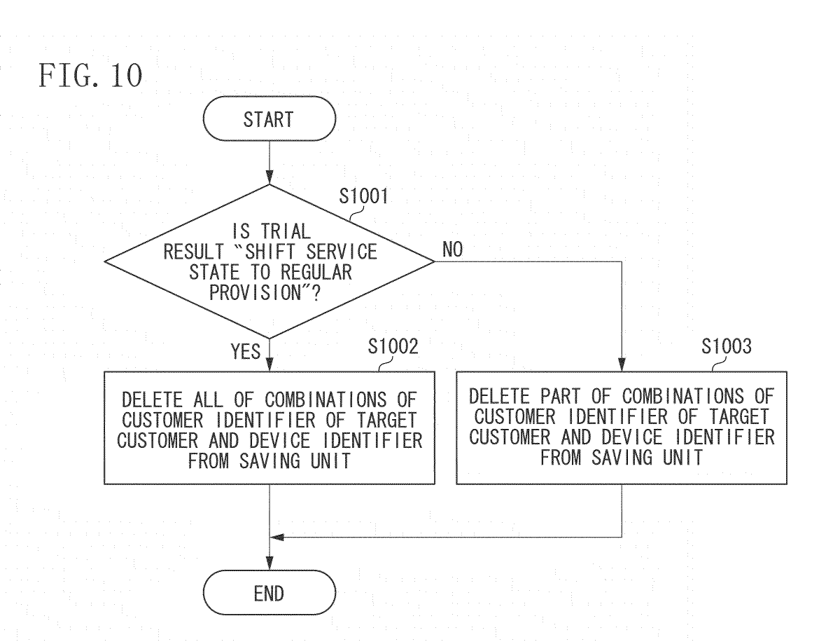

FIG. 10 is a flowchart illustrating an example of a flow of processing executed by the device management server 101 when the customer ends the trial. The CPU 301 of the device management server 101 executes a program stored in the hard disk 303 to realize the processing of this flowchart.

In step S1001, the determination unit 403 determines whether “SHIFT SERVICE STATE TO REGULAR PROVISION” is selected as a trial result when the customer ends the trial. The user can select the trial result from the options, “SHIFT SERVICE STATE TO REGULAR PROVISION” and “DO NOT SHIFT SERVICE STATE TO REGULAR PROVISION” when the customer ends the trial. In the present exemplary embodiment, although “SHIFT SERVICE STATE TO REGULAR PROVISION” and “DO NOT SHIFT SERVICE STATE TO REGULAR PROVISION” are provided as the possible options of the trial result to be selected when the customer ends the trial, the options other than those may be provided. The option of the trial result that is to be selected when the customer ends the trial may be explicitly selected by the user on the web page, or may be selected automatically when a predetermined period of time has passed from the time point at which the trial is started.

In step S1001, in a case where the determination unit 403 determines that the trial result is “SHIFT SERVICE STATE TO REGULAR PROVISION” (YES in step S1001), the processing proceeds to step S1002. On the other hand, in a case where the determination unit 403 determines that the trial result is other than “SHIFT SERVICE STATE TO REGULAR PROVISION” (NO in step S1001), the processing proceeds to step S1003.

In step S1002, the deletion unit 406 specifies the customer identifier of the target customer and deletes all of the combinations of the specified customer identifier and the device identifier from the saving unit 404. In this case, the above deletion can be executed without any problem because the customer already shifted the service state to the regular provision is less likely to carry out the trial again. Therefore, it is possible to increase the data searching speed in the saving unit 404 by deleting the unnecessary data from the saving unit 404.

In step S1003, the deletion unit 406 specifies the customer identifier of the target customer and deletes a part of the combinations of the specified customer identifier and the device identifier from the saving unit 404. The above deletion is executed in order to increase the speed for searching for the data in the saving unit 404. A part of the combinations of the customer identifier and the device identifier as a deletion target is determined according to deletion conditions. The deletion conditions can be set to device usage data stored in the individual customer information saving unit 402 corresponding to the target customer. For example, when the device is a multifunction peripheral, the deletion conditions may be set to the device usage data such as the number of times of login, the number of times of printing, the number of times of facsimile transmission, and the number of times of scanning operations. Thus, a combination of the customer identifier and the device identifier can be determined to be the deletion target when the device corresponding to that device identifier included in the combination does not satisfy the predetermined threshold value set to a combination of the device usage data or a predetermined threshold ratio set to the entire device usage data. In addition, a part of the deletion conditions for deleting the combination of the customer identifier and the device identifier may be determined at random. A part of the deletion conditions may be determined at random because if the deletion conditions are set uniquely, the customer having malicious intent can avoid the detection of the repeated-trial by operating the device to satisfy the deletion conditions in a case where the customer can find out the deletion conditions in some way. The processing can be executed more effectively by combining the above-described methods. Further, in the present exemplary embodiment, the device information saved in the individual customer information saving unit 402 is not deleted. However, the device information saved in the individual customer information saving unit 402 corresponding to the combination of the customer identifier and the device identifier deleted in step S1003 may be deleted.

Further, although the processing is not illustrated in FIG. 10, the deletion unit 406 may delete all of the combinations of the customer identifier and the device identifier saved in the saving unit 404 at the timing when the device management system is updated (i.e., at the timing when the service provided by the device management system is updated). The deletion of the combinations of the customer identifier and the device identifier can be executed at the above-described timing because carrying out the trial after the update is allowable in terms of reassessment of the system if the customer has carried out the trial before the device management system is updated.

However, in this case, the repeated-trial executed by the customer not appropriate to the above condition cannot be detected. In order to solve this problem, instead of executing the deletion, the combination of the customer identifier and the device identifier may be saved in the saving unit 404 together with the information indicating in what version the trial has been carried out. With this configuration, the above problem can be solved by notifying in what version the past trial has been carried out, or by notifying that the version with which the trial has been carried out is different from the current version when the notification unit 405 sends a notification.

As described above, the repeated-trial of the service carried out by the customer can be detected more precisely while the data searching speed in the saving unit 404 can be further increased.

In comparison to the first to the third exemplary embodiments, a configuration described in a fourth exemplary embodiment is more desirable in terms of security. In the first to the third exemplary embodiments, the device identifiers extracted from the device information have been aggregated and saved in a single saving unit (i.e., saving unit 404) instead of saving for each of the customers. Because the device identifier can be the security information relating to the confidential matters of the customer, the above-described management method in which the device identifiers are aggregated and saved in a single saving unit may not be appropriate in terms of security.

Further, even if the device identifier is managed for each customer, the contractual relationship will be lost between the management company and the customer if the customer ends the trial without shifting the service state to the regular provision. Therefore, saving a part of the customer data continuously may be problematic in terms of security. In the present exemplary embodiment, only a configuration for solving the above problem, which is different from the configurations described in the first to the third exemplary embodiments, will be described.

The determination unit 403 extracts the device identifier uniquely identifying the device from the individual customer information saving unit 402 and generates a concealed device identifier by executing conceal processing on the device identifier. Definition of the device identifier for uniquely identifying the device is the same as that described in the first exemplary embodiment. The conceal processing can be executed by a method generally known as “hashing”. In the hashing method, a predetermined calculation is internally executed on a received character string to generate another character string called as “hash value”. The above calculation method is generally known, and thus the description thereof will be omitted.

The hash value is characterized in that the same hash value is always generated instead of being generated randomly if the same character string is input thereto. Further, the hash value is characterized in that the same hash value may possibly be acquired from a different original character string on rare occasions. Furthermore, the hash value is characterized in that it is extremely difficult to estimate the original character string from the hash value. Because of the above-described characteristics, in many cases, the hashing method is generally employed as a saving method of a password in which high priority is placed on the security. Naturally, the conceal method is not limited to the hashing method, and any method having the above-described characteristics, i.e., any method particularly characterized in that the same result is always output when the same character string is input thereto, and that it is extremely difficult or impossible to estimate the original character string, can be employed as the conceal method.

In the present exemplary embodiment, the processing is executed by replacing all of the device identifiers processed by the saving unit 404 and the determination unit 403 described in the first to the third exemplary embodiments by the above-described concealed device identifiers. With this configuration, the above problem relating to the security can be solved. Further, in a case where the conceal processing is executed by the hashing method, the characteristic in which the same hash value may possibly be acquired from a different original character string on rare occasions can be solved by the configuration described in the second exemplary embodiment in which the notification is not sent unless a predetermined notification condition is satisfied. In this case, a message indicating the above-described possibility (i.e., another device may possibly be identified as the same device because of the characteristics of the hashing method) may be added to the notice message as described in the 27th line of the e-mail illustrated in FIG. 6.

FIG. 5B is an example of a data table for managing the combination of the customer identifier and the device identifier saved in the saving unit 404 according to the present exemplary embodiment.

The same customer ID as in the customer identifier 501 described in FIG. 5A is saved in a customer identifier 503. Further, the hashing processing is executed on a character string acquired by eliminating symbols from the MAC address extracted from the device information of the device transmitted from the customer environment, and that hashed character string is saved in a concealed device identifier 504. As described above, the saving unit 404 according to the present exemplary embodiment manages the device identifier in a concealed state.

As described above, the repeated-trial of the service carried out by the customer can be detected more precisely while the information of the customer can be saved with a higher security level.

In each of the above-described exemplary embodiments, description has been given to the configuration in which the device management system manages the information (device identification information) for identifying the image forming apparatus installed in the customer's network environment as the management information necessary for the service provider to provide a service to the customer. However, the above-described management information is not limited to the device identification information of the image forming apparatus. Device identification information of a device other than the image forming apparatus, such as device identification information of a network device installed in the network environment of the customer can be used as the management information. Furthermore, other management information acquirable from the network environment of the customer can be used as the management information instead of the device identification information of the device.

As described above, according to the present invention, it is possible to reliably determine and detect whether the customer to whom the service is to be specially provided corresponds to a customer to whom the special provision of the service has been implemented in the past. In other words, the device management server 101 can precisely detect that the trial is likely to be implemented in the customer environment where the trial has been implemented in the past.

Further, configurations and the contents of the above-described various types of data are not limited thereto, and thus the configurations and the contents thereof may be configured in various ways according to the usage or the purpose.

While the exemplary embodiments of the present invention has been described in detail, it is to be understood that the present invention can be also realized with, for example, a system, an apparatus, a method, a program, or a storage medium. Specifically, the present invention is applicable to a system configured of a plurality of devices, or an apparatus configured of a single device.

Furthermore, any configuration in which the above-described exemplary embodiments are combined with each other is also included in the present invention.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-091589 filed Apr. 25, 2014, which is hereby incorporated by reference herein in its entirety.

What is claimed is:

1. A management system configured to manage management information necessary for a service provider to provide a service to a customer for each customer, the management system comprising:
a generation unit configured to generate a customer identifier for identifying a specific customer when special provision of the service is started for the specific customer;
an acquisition unit configured to acquire management information from a network environment of the specific customer whose customer identifier is generated by the generation unit;
a management unit configured to manage the management information acquired from the network environment of the specific customer in association with the specific customer identifier in order to manage the customer to whom the special provision of the service has been implemented;
a registration unit configured to register the management information on the management unit in association with the customer identifier of the specific customer in a case where the management information is acquired from the network environment of the specific customer and if the management information is not managed by the management unit;
a notification unit configured to send a notification in a case where the management information is acquired from the network environment of the specific customer, if the management information has already been managed by the management unit, and the customer identifier of the specific customer generated by the generation unit is different from the customer identifier associated with the management information already managed by the management unit.

2. The management system according to claim 1, further comprising:
a deletion unit configured to delete all of the management information associated with the customer identifier of the specific customer from the management unit in a case where regular provision of the service is implemented for the specific customer while terminating the special provision of the service.

3. The management system according to claim 2,
wherein the deletion unit deletes a part of the management information associated with the customer identifier of the specific customer from the management unit in a case where the regular provision of the service is not implemented for the specific customer even if the special provision of the service is terminated.

4. The management system according to claim 2,
wherein the deletion unit deletes all of the management information managed by the management unit according to an update of the provided service.

5. The management system according to claim 1, further comprising:
a saving unit configured to save a number of times of determinations for each customer identifier in a case where the management information is acquired from the network environment of the specific customer if the management information has already been managed by the management unit, and the customer identifier of the specific customer generated by the generation unit is determined to be different from the customer identifier associated with the management information already managed by the management unit;
wherein the notification unit sends a notification in a case where the number of times of determinations executed for the specific customer satisfies a predetermined condition.

6. The management system according to claim 1,
wherein the notification indicates that the special provision of the service is implemented repeatedly.

7. The management system according to claim 6,
wherein the notification includes the management information determined to be managed by the management unit in a state of being associated with a customer identifier different from the customer identifier of the specific customer.

8. The management system according to claim 1,
wherein the management information managed by the management unit for managing a customer already implemented the special provision of the service includes information for identifying a network device installed in a network environment of a customer.

9. The management system according to claim 1,
wherein the special provision of the service for the specific customer is provision allowing the specific customer to carry out a trial of the service.

10. The management system according to claim 1,
wherein the management unit manages the management information associated with the customer identifier of the specific customer in a concealed state.

11. A control method for managing management information necessary for a service provider to provide a service to a customer for each customer, the control method comprising:
generating, by a generation unit, a customer identifier for identifying a specific customer in a case where special provision of the service is started for the specific customer;
acquiring, by an acquisition unit, management information from a network environment of the specific customer whose customer identifier is generated by the generation unit;
managing, by a management unit, the management information acquired from the network environment of the specific customer in association with the customer identifier in order to manage the customer to whom the special provision of the service has been implemented;
registering, by a registration unit, management information on the management unit in association with the customer identifier of the specific customer in a case where the management information is acquired from the network environment of the specific customer while that management information is not managed by the management unit;
sending a notification, by a notification unit, in a case where the management information is acquired from the network environment of the specific customer if the management information has already been managed by the management unit, and the customer identifier of the specific customer generated by the generation unit is different from the customer identifier associated with the management information already managed by the management unit.
